(19) United States
(12) Patent Application Publication
(10) Pub. No.: US 2023/0306936 A1
(43) Pub. Date: Sep. 28, 2023

(54) APPARATUS AND METHOD FOR SUSPENDING A MUSICAL INSTRUMENT

(71) Applicant: Reginald Helm, Chicago, IL (US)

(72) Inventor: Reginald Helm, Chicago, IL (US)

(21) Appl. No.: 18/189,456

(22) Filed: Mar. 24, 2023

Related U.S. Application Data
(60) Provisional application No. 63/269,858, filed on Mar. 24, 2022.

(51) Int. Cl. G10G 5/00; G10D 9/00

(52) U.S. Cl. CPC G10G 5/005; G10D 9/00

(57) ABSTRACT

Apparatus and method for suspending a musical instrument from a musician's neck includes an instrument suspension strap and cooperating garment collar configured for cooperative connection to carry a musical instrument. The instrument suspension strap includes a distal end having a fastener for coupling with an attachment point on the musical instrument. A pair of suspension straps extend from the distal end to a proximal end. The pair of suspension straps carry a first side of a cooperating fastener. A garment collar is configured with one or more second sides of the cooperating fastener. The suspension apparatus and method allow a musician to conveniently carry their instrument without a bunching or binding and aggravation of their neck.

### CROSS-REFERENCE TO RELATED APPLICATIONS

This application claims the benefit of priority of U.S. provisional application No. 63/269,858, filed Mar. 24, 2022, the contents of which are herein incorporated by reference.

### BACKGROUND OF THE INVENTION

The present invention relates to musical instruments, and more particularly to suspension apparatus and methods for woodwind instruments.

Conventional suspension apparatus for woodwind instruments, such as a saxophone include a stand-alone strap, formed as a loop that is suspended about the musician's neck. A coupling at a distal end of the strap is configured for cooperative engagement with an attachment point on the instrument. These conventional suspension apparatuses leave marks around the wearer's neck and can be uncomfortable

The Other devices are designed to wrap directly around the back of the neck. While playing the saxophone for a length of time, that direct connection of having the strap resting on the back of the musician's neck, while holding the weight of the saxophone, can be irritating.

As can be seen, there is a need for an improved apparatus and method for suspending a musical instrument.

### SUMMARY OF THE INVENTION

In one aspect of the present invention, an apparatus for suspending a musical instrument is disclosed. The apparatus includes a pair of suspension straps having a longitudinal length, a proximal end, and a distal end. An instrument fastener is coupled with the distal end of the pair of suspension straps, the instrument fastener adapted to couple with an attachment point of the musical instrument. A first side of a cooperating fastener is provided near the proximal end of each of the pair of suspension straps. The first side of the cooperating fastener is adapted to couple with a second side of the cooperating fastener disposed on opposed ends of a band of a garment collar.

In some embodiments, a plurality of the first side of the cooperating fastener are disposed along the longitudinal length of the pair of suspension straps near the proximal end.

In some embodiments, an adjuster engageable with the pair of suspension straps, the adjuster configured to selectively adjust the longitudinal length of the pair of suspension straps between the proximal end and the instrument fastener. The instrument fastener is selectively engageable with an attachment point of the musical instrument.

In other aspects of the invention, an apparatus for suspending a musical instrument is disclosed. The apparatus includes an instrument suspension strap having a first free end and a second free end at a proximal end thereof. A first side of a cooperating fastener is provided on each of the first free end and the second free end. An instrument fastener is coupled with a distal end of the instrument suspension strap. The instrument fastener adapted to couple with an attachment point of the musical instrument. A garment having a band that is configured to encircle a neck of a wearer includes a second side of the cooperating fastener provided on opposed ends of the band.

In some embodiments, a plurality of the first side of the cooperating fastener are disposed along a longitudinal length of the first free end. A plurality of the first side of the cooperating fastener may be disposed along a longitudinal length of the second free end.

In some embodiments, a plurality of second sides of the cooperating fastener are disposed along a circumferential aspect of the band.

In some embodiments, an adjuster is configured to adjust a longitudinal length of the instrument suspension strap between the instrument fastener and at least one of the first free and the second free end.

In other embodiments, a protruding portion of the cooperating fastener is coupled with the band.

In yet another embodiment, the instrument suspension strap includes a corded material interposed between the instrument fastener and each of the first free end and the second free end.

In other aspects of the invention, a method of supporting a musical instrument with a musician is disclosed. The method includes providing an instrument suspension strap having a first free end and a second free end at a proximal end thereof, a first side of a cooperating fastener provided on each of the first free end and the second free end, and an instrument fastener coupled with a distal end of the instrument suspension strap. The first side of the cooperating fastener of the first free end is coupled with a second side of the cooperating fastener attached with a first end of a band of a collared garment worn by the musician. The first side of the cooperating fastener of the second free end is then coupled with a second side of the cooperating fastener attached with a second end of the band of the collared garment. The instrument fastener is then selectively coupled with the musical instrument.

In some embodiments, the method includes adjusting a supported elevation of the musical instrument relative to the musician.

These and other features, aspects and advantages of the present invention will become better understood with reference to the following drawings, description and claims.

### BRIEF DESCRIPTION OF DRAWINGS

FIG. 1 is a side perspective view of an instrument suspension strap.

FIG. 2 is an exploded side perspective view of the instrument suspension strap and a cooperating garment collar.

FIG. 3 is a side perspective view of the instrument suspension strap and the cooperating garment collar shown in an attached condition.

### DETAILED DESCRIPTION OF THE INVENTION

At least one specification heading is required. Please delete this heading section if it is not applicable to your application. For more information regarding the headings of the specification, please see MPEP 608.01(a).

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide an instrument suspension strap and cooperating garment collar configured for cooperative connection to carry a musical instrument.

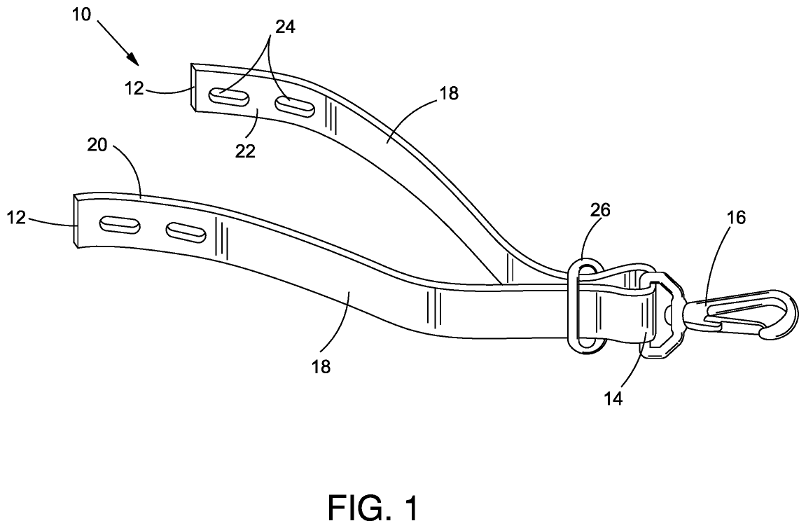

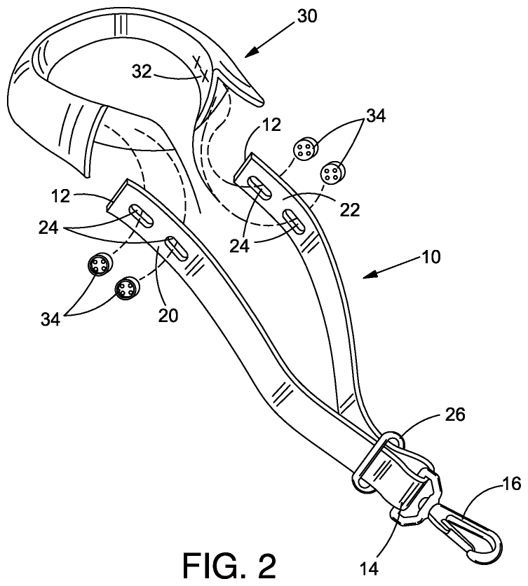

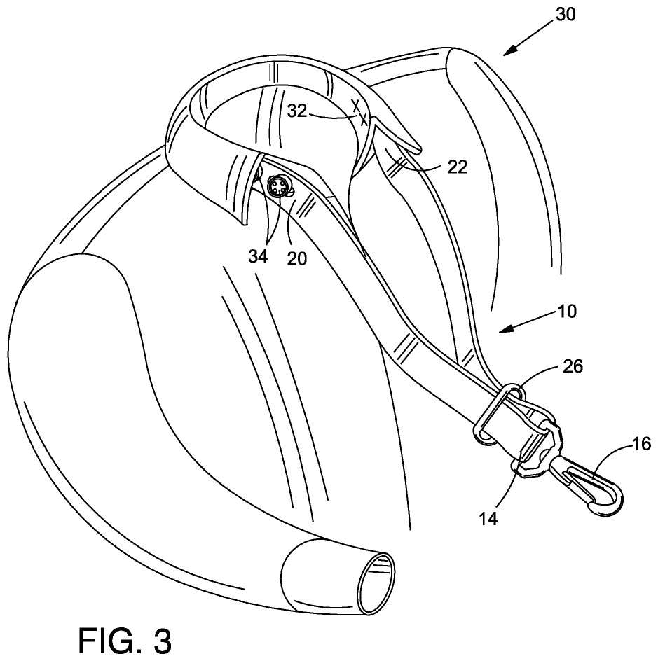

As seen in reference to the drawings of FIGS. 1-3, the instrument suspension strap 10 includes a proximal end 12 and a distal end a distal end 14 having an instrument fastener 16, such as a hook, for coupling with an attachment point on the musical instrument (not shown). A pair of suspension straps 18 extend from the distal end 12 to a proximal end 14.

As will be appreciated, the pair of suspension straps 18 may be formed from a unitary strap coupled with the instrument fastener 16, forming a first free end 20 and a second free end 22 at the proximal end of the instrument suspension strap 10.

The suspension straps 18 may be formed of a fabric material having a width of approximately 1 inch, a length between the proximal end 12 and the instrument fastener 16 that may be between about 7″ to 12″, and a length between the proximal end 12 and a distal end of the instrument fastener of between about 10″ to 15″. The foregoing dimensions are of course relative based on the size, age, and stature of the musician, and the size and positioning of the attachment point on the musical instrument. Youth and petite sizes would be relatively shorter, while adult and taller musicians may require an additional length.

Likewise, the suspension straps 18 may be formed with the free ends 20, 22 formed as a strap, while an intermediate portion and distal end portion of the suspension straps 18 being formed of a braided or a corded material, providing the musician a lighter weight and improved freedom of movement.

The first free end 20 and the second free end 22 carry a first side of a cooperating fastener 24, where the cooperating fastener is selected from the group consisting of a button-button hole, a snap, a hook and a loop. Preferably, a protruding portion of the cooperating fastener is coupled with the

In the non-limiting embodiment shown, the first side of the cooperating fastener 24 includes one or more buttonholes at each of the proximal ends 20, 22 of the suspension straps 18. The one or more buttonholes may be disposed in a spaced apart relation along a longitudinal length of the suspension strap 18. An adjuster may be provided between the proximal end and the distal end for adjusting the longitudinal length of the suspension strap.

A collared garment 30, such as a shirt, jacket, and the like, is configured with one or more second sides 34 of the cooperating fastener coupled with a band 32 of the collared garment 30 at forward lateral sides thereof. In the non-limiting embodiment shown, the second side 34 of the cooperating fastener includes a plurality of buttons, configured for cooperative engagement with the first side 24 of the cooperating fastener of the suspension strap 18. The band 32 of the collared garment 30 typically has a reinforced, multi-layer structure. Additional reinforcement may be provided to the band 32 of the collared garment 30. The collared garment 30 may include a collar 36 extending from the band 32. Likewise, the band 32 itself may constitute the extent of a collar for the collared garment 30.

In use, the instrument suspension strap 10 is attached with the cooperating fasteners carried on the band 32 and made into the collared garment 30 so no direct pressure from the strap holding the weight of the musical instrument, such as a saxophone is suspended by direct support from the musician's neck. Because instrument suspension strap 10 is attached to band 32 of the collared garment 30, the weight is transferred and distributed using the strength built into the collared garment 30, without a bunching of the collar beneath a strap. The instrument suspension strap 10 of the present invention transfers and distributes weight of the musical instrument using the built-in strength of the band 32 of the collared garment 30 when the musical instrument is coupled with the instrument suspension strap 10.

The first side 24 of the cooperating fastener at first free end 18 of the instrument suspension strap 10 is coupled with the second side 34 of the cooperating fastener on the band 32 of the collared garment 30. The first side 24 of the cooperating fastener at the second free end 18 of the instrument suspension strap 10 may then be coupled with the second side 34 of the cooperating fastener on the opposite end of the band 32 of the collared garment 30.

adjuster 26 may be utilized to adjust the longitudinal length of the instrument suspension strap 10, such that the instrument fastener 16 is positioned at a desired elevation relative to the musician's body. The musician may then use the instrument fastener 16 to selectively couple the instrument suspension strap 10 with the attachment point of their musical instrument.

It should be understood, of course, that the foregoing relates to exemplary embodiments of the invention and that modifications may be made without departing from the spirit and scope of the invention as set forth herein.

I claim:

1. An apparatus for suspending a musical instrument, comprising:
a pair of suspension straps have a longitudinal length, a proximal end, and a distal end;
an instrument fastener coupled with the distal end of the pair of suspension straps, the instrument fastener adapted to couple with an attachment point of the musical instrument; and
a first side of a cooperating fastener provided near the proximal end of each of the pair of suspension straps, the cooperating fastener adapted to couple with a second side of a cooperating fastener disposed on opposed ends of a garment collar.

2. The apparatus of claim 1, further comprising:
a plurality of the first side of the cooperating fastener disposed along the longitudinal length of the pair of suspension straps near the proximal end.

3. The apparatus of claim 1, further comprising:
an adjuster engageable with the pair of suspension straps, the adjuster configured to selectively adjust the longitudinal length of the pair of suspension straps between the proximal end and the instrument fastener.

4. The apparatus of claim 1, wherein the instrument fastener is selectively engageable with an attachment point of the musical instrument.

5. An apparatus for suspending a musical instrument, comprising:
an instrument suspension strap having a first free end and a second free end at a proximal end thereof
a first side of a cooperating fastener provided on each of the first free end and the second free end;
an instrument fastener coupled with a distal end of the instrument suspension strap, the instrument fastener adapted to couple with an attachment point of the musical instrument;
a garment having a band configured to encircle a neck of a wearer; and
a second side of the cooperating fastener provided on opposed ends of the band.

6. The Apparatus of claim 5, further comprising:
a plurality of the first side of the cooperating fastener disposed along a longitudinal length of the first free end.

7. The Apparatus of claim 5, further comprising:
a plurality of the first side of the cooperating fastener disposed along a longitudinal length of the second free end.

8. The apparatus of claim 5, further comprising:
a plurality of second sides of the cooperating fastener disposed along a circumferential aspect of the band.

9. The apparatus of claim 5, further comprising:
an adjuster configured to adjust a longitudinal length of the instrument suspension strap between the instrument fastener and at least one of the first free and the second free end.

10. The apparatus of claim 5, wherein a protruding portion of the cooperating fastener is coupled with the band.

11. The apparatus of claim 5, the instrument suspension strap further comprising:
a corded material interposed between the instrument fastener and each of the first free end and the second free end.

12. A method of supporting a musical instrument with a musician, comprising:
providing an instrument suspension strap having a first free end and a second free end at a proximal end thereof, a first side of a cooperating fastener provided on each of the first free end and the second free end, and an instrument fastener coupled with a distal end of the instrument suspension strap;
coupling the first side of the cooperating fastener of the first free end with a second side of the cooperating fastener attached with a first end of a band of a collared garment worn by the musician;
coupling the first side of the cooperating fastener of the second free end with a second side of the cooperating fastener attached with a second end of the band of the collared garment; and
selectively coupling the instrument fastener with the musical instrument.

13. The method of claim 12, further comprising:
adjusting a supported elevation of the musical instrument relative to the musician.
